(19) United States
(12) Patent Application Publication
(10) Pub. No.: US 2011/0244198 A1
(43) Pub. Date: Oct. 6, 2011

(54) HOLDING SEALING MATERIAL

(75) Inventors: Mitsunori YOSHIMI, Takahama-shi (JP); Fumihito Asano, Takahama-shi (JP)

(73) Assignee: IBIDEN CO., LTD., Ogaki-Shi (JP)

(21) Appl. No.: 13/076,436

(22) Filed: Mar. 31, 2011

(30) Foreign Application Priority Data
Mar. 31, 2010 (JP) 2010-083769

(51) Int. Cl. B32B 3/00

(52) U.S. Cl. 428/196

(57) ABSTRACT

A holding sealing material includes at least one mat and at least one thread. The at least one mat includes inorganic fibers. The at least one thread is sewn in the at least one mat to provide identification information on the at least one mat.

### CROSS-REFERENCE TO RELATED APPLICATIONS

The present application claims priority under 35 U.S.C. §119 to Japanese Patent Application No. JP 2010-083769 filed on Mar. 31, 2010, the contents of which are incorporated herein by reference in their entirety.

### BACKGROUND OF THE INVENTION

1. Field of the Invention

The present invention relates to a holding sealing material.

2. Discussion of the Background

Particulate matters (hereinafter, also referred to as PMs) are contained in exhaust gases discharged from internal combustion engines such as diesel engines, and in recent years, there has arisen a serious problem that these PMs are harmful to the environment and the human bodies. Moreover, since exhaust gases also contain toxic gas components such as CO, HC, and NOx, there have been growing concerns about influences of these toxic gas components on the environment and the human bodies.

In view of these, as an exhaust gas purifying apparatus for capturing PMs in exhaust gases and for converting the toxic gas components, various exhaust gas purifying apparatuses have been proposed. Each of the exhaust gas purifying apparatuses is configured by an exhaust gas treating body made of porous ceramics, such as silicon carbide and cordierite, a casing configured to accommodate the exhaust gas treating body, and a holding sealing material made of inorganic fibers which is disposed between the exhaust gas treating body and the casing. This holding sealing material is installed mainly for purposes of preventing the exhaust gas treating body from being damaged upon contact with the casing which covers its periphery because of vibrations and impacts caused by driving or the like of an automobile and of preventing exhaust gases from leaking from between the exhaust gas treating body and the casing.

As the holding sealing material including inorganic fibers, a holding sealing material composed of a mat is known as described in JP-A 2003-214156. Further, as described in JP-A 2007-218221, a holding sealing material formed by laminating a plurality of mats is also known.

The contents of JP-A 2003-214156 and JP-A 2007-218221 are incorporated herein by reference in their entirety.

### SUMMARY OF THE INVENTION

According to one aspect of the present invention, a holding sealing material includes at least one mat and at least one thread. The at least one mat includes inorganic fibers. The at least one thread is sewn in the at least one mat to provide identification information on the at least one mat.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view schematically showing an example of a holding sealing material of a first embodiment of the present invention;

FIG. 2 is a cross-sectional view schematically showing a part of a portion formed by machine-sewing in the holding sealing material shown in FIG. 1;

FIG. 3A is a perspective view schematically showing an example of an exhaust gas purifying apparatus; and FIG. 3B is an A-A line cross-sectional view of the exhaust gas purifying apparatus illustrated in FIG. 3A;

FIG. 4A is a perspective view schematically showing an example of a honeycomb filter; and FIG. 4B is a perspective view schematically showing an example of a casing;

FIG. 5 is a perspective view schematically showing a procedure of manufacturing the exhaust gas purifying apparatus;

FIG. 6A shows photographs before and after a vibration test of identification information provided by a thread in the holding sealing material manufactured in Example 1; FIG. 6B shows photographs before and after a vibration test of identification information provided by ink jet printing in the holding sealing material manufactured in Comparative Example 1; and FIG. 6C shows photographs before and after a vibration test of identification information provided by a printed adhesive label in the holding sealing material manufactured in Comparative Example 2;

FIG. 7 is a plan view schematically showing an example of a holding sealing material of a second embodiment of the present invention;

FIG. 8 is a plan view schematically showing an example of a holding sealing material of a third embodiment of the present invention;

FIG. 9 is a cross-sectional view schematically showing a part of a cross-section of a holding sealing material of a fourth embodiment of the present invention; and

FIG. 10 is a plan view schematically showing an example of a holding sealing material of a fifth embodiment of the present invention.

### DESCRIPTION OF THE EMBODIMENTS

The embodiments will now be described with reference to the accompanying drawings, wherein like reference numerals designate corresponding or identical elements throughout the various drawings.

A mat composing a holding sealing material has different surface roughness between the front and the back resulting from its production process. Generally, it is desirable from the viewpoint of improving a winding property at the time of winding the holding sealing material around the exhaust gas treating body that a smoother face having small surface roughness is used as a face to contact with the exhaust gas treating body. Therefore, there is differentiation between the front and the back in the holding sealing material, and a face to contact with the exhaust gas treating body and a face to contact with the casing are determined in advance.

When a holding sealing material composed of a mat is used, discrimination between the front and the back of the holding sealing material is performed according to worker's feeling based on the difference in the feel between the front and the back of the holding sealing material. Therefore, when the worker is not skilled in discrimination between the front and the back, there might be cases where the holding sealing material is disposed the back to the front in the exhaust gas purifying apparatus to impair workability.

In JP-A 2003-214156, it is described that in order to discriminate between the front and the back of the holding sealing material, either surface of the mat is colored with an organic or inorganic pigment.

However, the pigment affixed to the surface of the mat may fall off due to friction or vibrations during transportation of the mat and coloring may become blurred.

Further, since the mat is often impregnated with an organic binder and the pigment is hardly affixed to the organic binder, there is a problem that the pigment affixed to the mat is apt to fall off from the mat and coloring becomes blurred. Accordingly, there may be cases where the holding sealing material is disposed the back to the front in the exhaust gas purifying apparatus.

Further, the holding sealing material composed of a plurality of mats includes an outer side mat having a comparatively long length in a longitudinal direction and an inner side mat having a comparatively short length in a longitudinal direction. Such a holding sealing material is arranged in such a way that the outer side mat is brought into contact with a casing and the inner side mat is brought into contact with the exhaust gas treating body. When the holding sealing material is thus arranged, each of the inner side mat and the outer side mat is fitted without space, and therefore a stronger retaining force can be obtained.

That is, also when the holding sealing material composed of a plurality of mats is used, it is necessary to dispose the holding sealing material in the exhaust gas purifying apparatus, discriminating between the front and the back of the holding sealing material.

When the holding sealing material is disposed the back to the front in the exhaust gas purifying apparatus, there is a problem that a strong retaining force is not achieved.

In JP-A 2007-218221, it is described that a plurality of mats are fixed to one another by providing a binding portion by sewing processing.

The discrimination between the front and the back of the holding sealing material, which is formed by fixing a plurality of mats by such a method, is often performed by worker's visual observation of lengths of the outer side mat and the inner side mat in a longitudinal direction. However, as described in drawings in JP-A 2007-218221, when both ends of one mat of a plurality of mats deviate from those of another mat, it may require extra work to check lengths of the mats. Therefore, a holding sealing material, two sides of which tends to be easily determined more simply, is desired.

Further, information such as a lot number, a manufacturing history and the like is provided on the mat. Providing information on the mat is carried out by a method in which information is printed directly on the mat by ink jet printing or a tape with information printed is stuck to the mat.

However, information printed directly on a mat by ink jet printing may become blurred. Moreover, the information printed directly on a mat by ink jet printing may further become blurred resulting from rubbing in packaging or transporting the holding sealing material.

Further, a tape on which the information is printed may be peeled off by rubbing in packaging or transporting the holding sealing material.

Further, when the tape on which the information is printed is stuck to a mat, there is a problem that the workability (winding property) at the time of winding the holding sealing material around the exhaust gas treating body is deteriorated.

A holding sealing material according to an embodiment of the present invention includes a mat including inorganic fibers and a thread sewn in the mat to provide identification information on the mat.

In the holding sealing material, identification information is provided on the mat by the thread sewn in the mat. Since the thread sewn in the mat is firmly fixed to the mat, it tends not to be peeled off or tends not to become blurred in packaging or transporting the holding sealing material. Further, the identification information provided by the thread is clearer than that printed directly on a mat by ink jet printing.

Moreover, the identification information provided by the thread is less likely to fall off from the mat in contrast to the identification information provided by a pigment affixed to the mat.

By thus providing the identification information with the thread, it becomes easier to provide clear identification information firmly on the mat.

When the mat is firmly provided with clear identification information, for example, even unskilled workers tends to easily discriminate between the front and the back of the holding sealing material.

Further, the thread providing identification information tends not to deteriorate the workability at the time of winding the holding sealing material around the exhaust gas treating body. That is, the holding sealing material provided with identification information by the thread also tends to be excellent in a winding property.

In the holding sealing material according to the embodiment of the present invention, the mat includes a plurality of mats laminated and the plurality of mats are desirably sewn with the thread.

In the aforementioned holding sealing material, it may become easier to fix a plurality of mats and to provide the identification information with the thread. That is, in accordance with the holding sealing material of the embodiment of the present invention, it may become easier to simplify a production process and reduce the number of members for producing the holding sealing material compared with the case where fixing of a plurality of mats and providing of the identification information are carried out by another way.

Further, since the front and the back of the holding sealing material are determined by sewing a plurality of mats with the thread to fix the mats, and since the identification information indicating the front and the back tends to be easily provided concurrently with the fixing of mats, the identification information indicating the front and the back of the holding sealing material is more likely to be prevented from being erroneously provided.

In the holding sealing material according to the embodiment of the present invention, the thread includes an upper thread exposed at a first face of the holding sealing material, and a bobbin thread exposed at a second face of the holding sealing material, and the color of the upper thread is desirably different from the color of the bobbin thread.

By distinguishing the color of the upper thread exposed at the first face of the holding sealing material from the color of the bobbin thread exposed at the second face of the holding sealing material, a worker tends to simply discriminate between the front and the back of the holding sealing material (the first face of the holding sealing and the second face of the holding sealing material) based on the difference in color more easily.

In the holding sealing material according to the embodiment of the present invention, an organic or inorganic pigment is desirably affixed to the thread. In the holding sealing material according to the embodiment of the present invention, an inorganic pigment is desirably affixed to the thread.

Since the pigment is easily affixed to the thread, peeling of the pigment is more likely to be prevented in contrast to the case where the pigment is affixed to the mat.

When an inorganic pigment is used as the pigment, since its heat resistance is high, the identification information tends to remain even after using the holding sealing material at a high-temperature location closed to an engine.

Therefore, even when failures of the holding sealing material occur after using the holding sealing material in a high-temperature environment, it may become easier to identify the identification information such as a manufacturing history of a product and the like.

In the holding sealing material according to the embodiment of the present invention, in a cross-section formed by cutting the holding sealing material along a thickness direction of the holding sealing material, the surface of the thread sewn in the mat is desirably located below a plane of a part of the mat where a thread is not sewn.

If the thread is located at such a position, since a possibility that the thread is brought into contact with another member and rubbed is decreased, the identification information tends to be maintained over a long time period in a clear state.

In the holding sealing material according to the embodiment of the present invention, an initiation point where sewing of the mat with the thread is initiated is desirably about 30 mm or more away from the periphery of the mat.

At the initiation point where sewing of the mat with the thread is initiated, an end portion of the thread is not used for sewing in sewing the mat, and the end portion becomes a free end. If the end portion of the thread sticks out of the periphery of the holding sealing material in a process for winding the holding sealing material around the exhaust gas treating body, it is not preferable since the thread may hitches on another location.

In the holding sealing material, when the initiation point where sewing of the mat by the thread is initiated is about 30 mm or more away from the periphery of the mat, a process for winding the holding sealing material around the exhaust gas treating body tends to be smoothly performed since the end portion of the thread tends not to stick out of the periphery of the holding sealing material.

### First Embodiment

Hereinafter, a first embodiment, which is an embodiment of a holding sealing material according to the present invention, will be described with reference to the drawings.

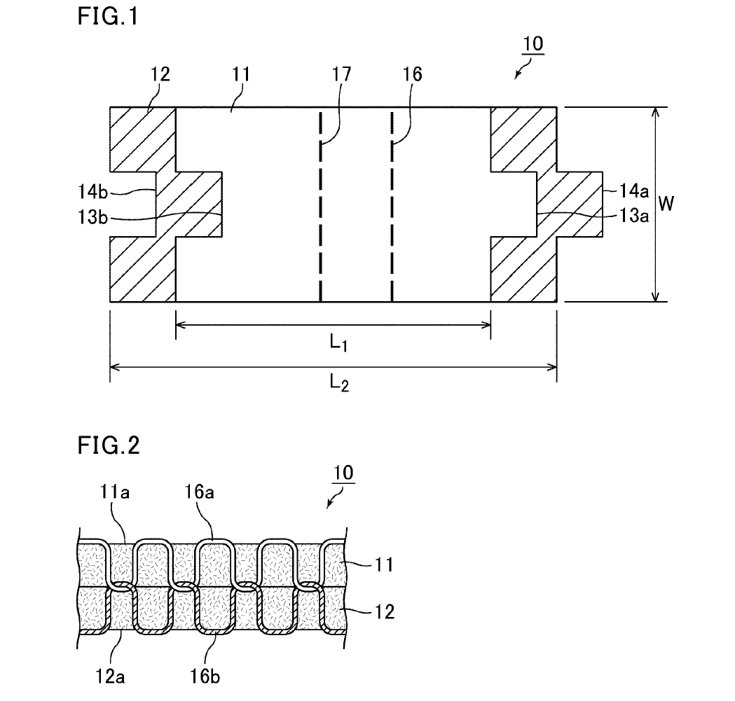

FIG. 1 is a plan view schematically showing an example of a holding sealing material of the first embodiment of the present invention.

As illustrated in FIG. 1, in the holding sealing material 10 of the present embodiment, two mats 11 and 12 having a substantially rectangular shape in a plan view and having a predetermined length (hereinafter, simply referred to as an entire length, and indicated by arrows L1 and L2 in FIG. 1) in a longitudinal direction, a width (indicated by an arrow W in FIG. 1), and a thickness are laminated.

In addition, projected portions 13a and 14a are formed at one end portion out of the end portions of the mats 11 and 12, and recessed portions 13b and 14b are formed at the other end portion. The projected portion 13a and the recessed portion 13b of the mat 11, and the projected portion 14a and the recessed portion 14b of the mat 12 have such shapes that they are perfectly fitted to each other upon winding the holding sealing material 10 around the exhaust gas treating body for assembling a exhaust gas purifying apparatus described later.

The mats 11 and 12 are prepared as needled mats obtained by needling a base mat composed of inorganic fibers. The needling treatment refers to a process in which a fiber entangling means such as a needle is inserted into and removed from the base mat. In the mats 11 and 12, inorganic fibers having a comparatively long average fiber length are entangled with one another three-dimensionally by the needling treatment. These mats are needled in the width direction perpendicular to the longitudinal direction.

Moreover, the inorganic fibers have a certain average fiber length to form the entangled structure, and, for example, the average fiber length of the inorganic fibers may be from about 50 μm to about 100 mm.

The holding sealing material of the present embodiment may further contain a binder such as an organic binder in order to suppress the volume of the holding sealing material and to enhance the workability prior to the assembling processes of the exhaust gas purifying apparatus.

Two mats having a thickness of from about 1.5 mm to about 15 mm are laminated in the holding sealing material 10 illustrated in FIG. 1, but the number of mats to be laminated is not particularly limited and may be three or more. A mat (hereinafter, also referred to as the shortest mat) having the shortest entire length out of a plurality of mats is a mat to be wound around the periphery of the exhaust gas treating body. Subsequently, a mat having an entire length longer than that of the shortest mat is laminated, and thereafter, a mat having a much longer entire length is sequentially laminated thereon. Here, the mat 11 is referred to as the shortest mat even in the case where the holding sealing material is configured by the two mats 11 and 12 like as the holding sealing material 10 shown in FIG. 1.

In the holding sealing material of the present embodiment, the mat 11 and the mat 12 are fixed to each other by two portions sewn with a thread, i.e., a portion sewn with a thread 16 and a portion sewn with a thread 17. The fixing method of the threads 16 and 17 in the holding sealing material of the present embodiment is machine-sewing, whereby the mats 11 and 12 are firmly fixed to each other.

Next, machine-sewing will be described in detail with reference to FIG. 2.

FIG. 2 is a cross-sectional view schematically showing a part of a portion formed by machine-sewing in the holding sealing material shown in FIG. 1.

As shown in FIG. 2, in the holding sealing material 10, the mats 11 and 12 are fixed by lock stitching (machine-sewing) with an upper thread 16a and a bobbin thread 16b.

In the holding sealing material 10, the thread 16 includes the upper thread 16a exposed at a first face 11a of the holding sealing material, one surface of the holding sealing material 10, and the bobbin thread 16b exposed at a second face 12a of the holding sealing material, the other surface of the holding sealing material 10.

Further, the color of the upper thread 16a is different from that of the bobbin thread 16b.

When the color of the upper thread 16a is different from that of the bobbin thread 16b, a worker handling the holding sealing material 10 tends to discriminate simply between the front and the back of the holding sealing material (the first face 11a of the holding sealing material and the second face 12a of the holding sealing material) based on the difference in color between the upper thread 16a and the bobbin thread 16b.

That is, it can be said that the thread 16 is identification information indicating the front and the back of the holding sealing material 10.

The color of the thread is not particularly limited and may be red, blue, yellow, green, black, or the like, and a combination of the colors, which are easily discriminated, may be selected from these colors.

Examples of the color combination include a combination of a red upper thread and a black bobbin thread.

Further, it is preferable that the color of the thread is not a transparent color and is different from the color of the mat.

A material and a diameter of the thread are not particularly limited, and the thread is preferably a sewing thread which has a diameter of from about 0.1 mm to about 5 mm and includes cotton or polyester.

Coloring of the thread is preferably performed with an organic or inorganic pigment affixed to the thread.

Further, a region, which is provided with the identification information with the thread (hereinafter, also referred to as a region provided with the identification information), is not particularly limited, but the region is preferably provided in a large size so that larger identification information is displayed for better facilitating worker's visual recognition.

As a specific area of the region provided with the identification information, an area, in which a maximum length of the region provided with the identification information is about 50 mm or more, is preferable.

More specifically, it is preferable to have a region provided with the identification information having a length substantially equal to a mat width (width of the holding sealing material) as shown in FIG. 1.

Next, a method for manufacturing a holding sealing material of the present embodiment will be described.

First, needled mats having predetermined entire lengths are prepared as mats which form a holding sealing material. The needled mat can be prepared by needling a base mat. The base mat has a structure in which inorganic fibers are loosely entangled with one another after undergoing a spinning process. By needling the inorganic fibers thus loosely entangled with one another, a mat having an entangled structure, in which the inorganic fibers are entangled with one another more complicatedly and its shape can be maintained to a certain degree without the presence of binder, can be formed.

This needling treatment is performed on a plurality of base mats having different lengths to prepare a plurality of mats required for manufacturing the holding sealing material of the present embodiment. Here, since the entire length of the shortest mat which is to be wound around the exhaust gas treating body corresponds to the circumferential length of the exhaust gas treating body, the entire length of the shortest mat is determined based on the circumferential length of the exhaust gas treating body in the first place. Since the entire length of a mat which is to be located outside the shortest mat corresponds to the circumferential length associated with the diameter which is obtained by adding the thickness of the shortest mat wound around the exhaust gas treating body to the diameter of the exhaust gas treating body, the entire length of the mat located outside the shortest mat is determined by obtaining the circumferential length in the second place. Each of the entire lengths of a plurality of mats to be laminated is determined by repeating the above-described procedure.

Thus, as required, a binder is allowed to be adhered to the mats which have undergone needling. By adhering the binder to the mats, the entangled structure among the inorganic fibers tends to be firmer, and the volume of the mats tends to be suppressed.

An emulsion, prepared by dispersing acrylic latex, rubber latex, or the like in water, may be used as the binder. This binder is sprayed evenly over the entire mat by using a spray or the like so that the binder adheres to the mat.

Thereafter, in order to remove moisture contained in the binder, the mat is dried. With respect to the drying condition, the binder may be dried under the condition of a drying temperature of from about 95° C. to about 150° C. and a drying time of from about 1 minute to about 30 minutes, for example. The mat can be prepared by undergoing the drying process.

In the present embodiment, the plurality of mats having different lengths are prepared and laminated in increasing order of length or in decreasing order of length. The number of mats to be laminated can be changed depending on the retaining force and heat insulating property which are required of the holding sealing material. A typical exemplary lamination order is such that a mat with the longest entire length is initially prepared, and then mats are sequentially laminated thereon so that the upper mat laminated on the lower mat has an entire length shorter than that of the lower mat. The relative position of the mats to be laminated may be such that the upper mat to be laminated having the shorter entire length may be laminated at a position not sticking out of either one of the ends of the lower mat having the longer entire length, or the upper mat may be laminated at a position sticking out of either one of the ends of the lower mat having the longer entire length by mutual displacement in the longitudinal direction.

Next, a plurality of mats laminated are fixed by threads to each other by machine-sewing. In this time, by performing machine-sewing by using the thread in which the color of the upper thread is different from the color of the bobbin thread, the color of the thread exposed at the front of the holding sealing material can be different from the color of the thread exposed at the back of the holding sealing material.

Examples of the specific method of machine-sewing include a method in which lock stitching, in which its stitch length is about 10 mm, is performed by using, as the upper thread, a thread having a diameter of about 1 mm and a red color and employing a Z twist as a second twist, and using, as the bobbin thread, a thread having a diameter of about 1 mm and a black color and employing a Z twist as a second twist, and reverse stitching is performed in the end portion of the fixed portion.

The holding sealing material of the present embodiment can be manufactured by such a method.

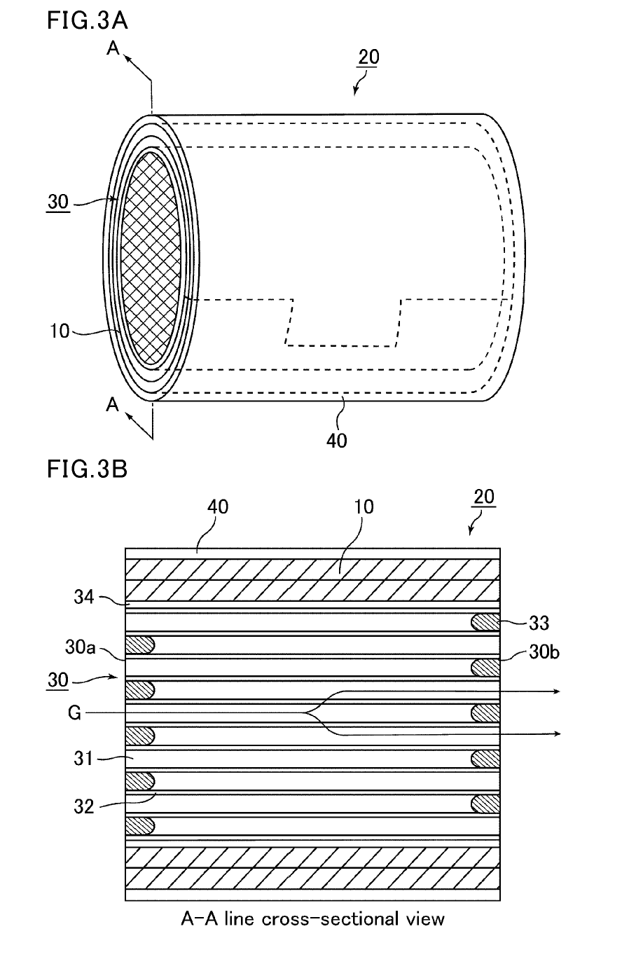

Next, an example of an exhaust gas purifying apparatus using the holding sealing material of the present embodiment will be described by use of FIG. 3A and FIG. 3B.

FIG. 3A is a perspective view schematically showing an example of the exhaust gas purifying apparatus, and FIG. 3B is an A-A line cross-sectional view of the exhaust gas purifying apparatus shown in FIG. 3A.

As shown in FIG. 3A and FIG. 3B, an exhaust gas purifying apparatus 20 includes a pillar-shaped exhaust gas treating body 30 in which a large number of cells 31 are longitudinally disposed in parallel with one another with a cell wall 32 interposed therebetween, a casing 40 configured to accommodate the exhaust gas treating body 30, and a holding sealing material 10 provided between the exhaust gas treating body 30 and the casing 40 and configured to hold the exhaust gas treating body 30.

If needed, to the end portions of the casing 40 are connected an introducing pipe configured to introduce exhaust gases discharged by internal combustion engines, and an exhaust pipe with which the exhaust gases which have passed through an exhaust gas purifying apparatus are discharged to the outside.

In the exhaust gas purifying apparatus 20, as shown in FIG. 3B, a honeycomb filter 30, in which either one of the ends of each of the cells is sealed with a plug 33, is employed as the exhaust gas treating body 30.

The case where exhaust gases pass through the exhaust gas purifying apparatus 20 having the above-mentioned configuration will be described below by use of FIG. 3B.

As shown in FIG. 3B, the exhaust gas (in FIG. 3B, the exhaust gas is indicated by G and the flow of the exhaust gas is indicated by arrows) discharged from the internal combustion engines and introduced into the exhaust gas purifying apparatus 20 flows into one cell 31 which opens onto an end face 30a of the exhaust gas inlet side in the honeycomb filter 30, and passes through a cell wall 32 separating the cell 31. At this time, PMs in the exhaust gas are captured in the cell wall 32, and as a result, the exhaust gas is purified. The purified exhaust gas flows out through another cell 31 opening onto the end face 30b of the exhaust gas outlet side, and is discharged to the outside.

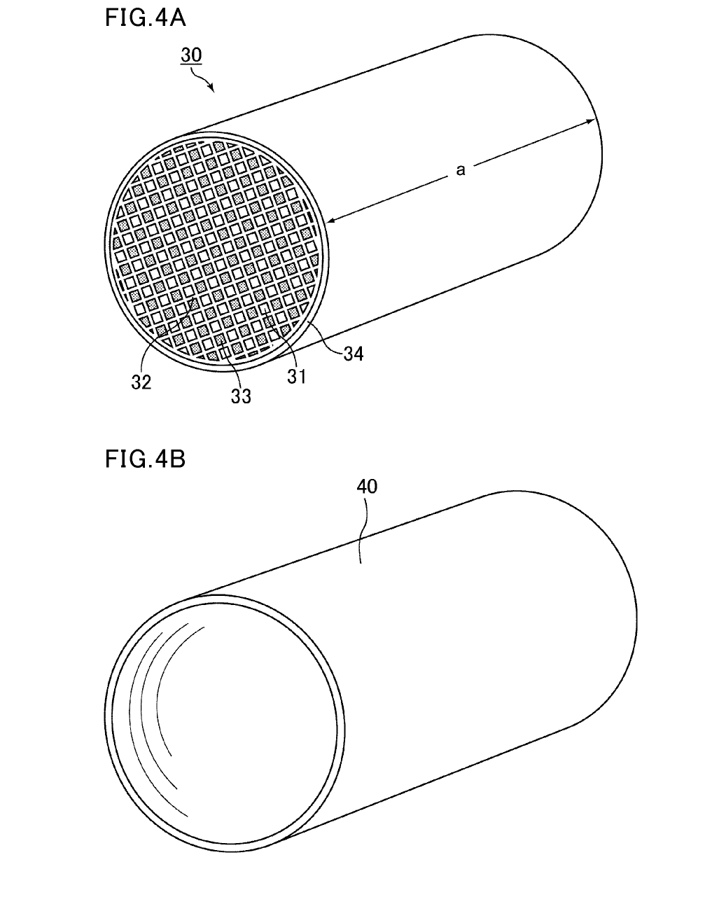

Next, a honeycomb filter and a casing which configure the exhaust gas purifying apparatus 20 will be described by use of FIG. 4A and FIG. 4B.

Here, the configuration of the holding sealing material 10 will be omitted because it has been already described.

FIG. 4A is a perspective view schematically showing an example of a honeycomb filter, and FIG. 4B is a perspective view schematically showing an example of a casing.

As shown in FIG. 4A, a honeycomb filter 30 mainly includes porous ceramics and has a round pillar shape. Moreover, a sealing material layer 34 is formed on the periphery of the honeycomb filter 30 for the purposes of reinforcing the peripheral portion of the honeycomb filter 30 and adjusting the shape of the peripheral portion thereof, and improving the heat insulating property of the honeycomb filter 30.

The internal configuration of the honeycomb filter 30 has been already stated in the description of the exhaust gas purifying apparatus of the present embodiment (refer to FIG. 3B).

Subsequently, the casing 40 will be described. The casing 40, shown in FIG. 4B, is mainly made of metal such as stainless, and it is formed into a circular cylindrical shape. Moreover, its inner diameter is slightly shorter than the total combined length of the diameter of the end face of the honeycomb filter 30 and the thickness of the holding sealing material 10 wound around the honeycomb filter 30, and its length is substantially the same as the length of the honeycomb filter 30 in the longitudinal direction (direction indicated by an arrow a in FIG. 4A).

Next, referring to the drawings, a method for manufacturing an exhaust gas purifying apparatus will be described.

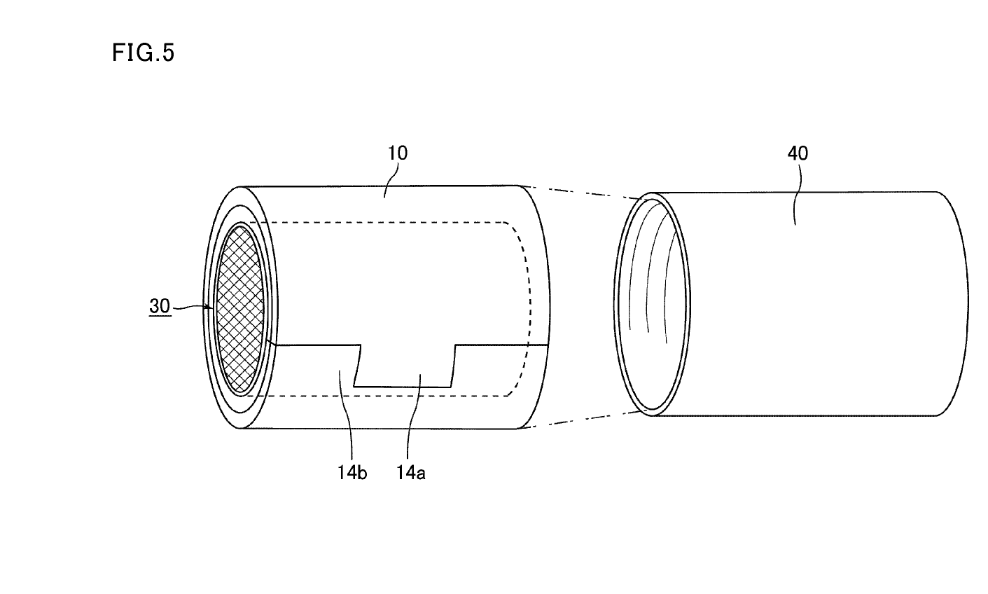

FIG. 5 is a perspective view schematically showing a procedure of manufacturing the exhaust gas purifying apparatus.

A holding sealing material 10, manufactured through the above processes, is wound around the periphery of a round pillar-shaped honeycomb filter 30 manufactured by a conventionally known method, with its projected portion 13a and recessed portion 13b being fitted to each other and with its projected portion 14a and recessed portion 14b being fitted to each other. Then, as shown in FIG. 5, the honeycomb filter 30 around which the holding sealing material 10 has been wound is stuffed into a casing 40 with a cylindrical shape having a predetermined size, mainly made of metal and the like, thus, an exhaust gas purifying apparatus is manufactured.

In order to compress the holding sealing material after the stuffing and exert a predetermined repulsive force (that is, force for retaining a honeycomb filter), the internal diameter of the casing 40 is a little smaller than the diameter of the outermost diameter of the honeycomb filter 30 around which the holding sealing material 10 has been wound, the outermost diameter including the thickness of the holding sealing material 10.

In the holding sealing material of the present embodiment, since a plurality of mats are firmly fixed to each other by sewing, upon winding the holding sealing material around the exhaust gas treating body, there is no displacement in the width direction, leading to favorable handleability.

Further, since the identification information of the front and the back is provided by the thread, the worker who winds the holding sealing material tends to simply discriminate simply between the front and the back of the holding sealing material.

Therefore, the holding sealing material is more likely to be prevented from being wound the back to the front.

Hereinafter, the effects of the holding sealing material and the exhaust gas purifying apparatus according to the present embodiment will be listed.

(1) In the holding sealing material of the present embodiment, a thread is sewn in the mat to provide identification information on the mat. Since the thread sewn in the mat is firmly fixed to the mat, it is not likely to be peeled off or tends not to become blurred in packaging or transporting the holding sealing material. Further, the identification information provided by the thread is clearer than that printed directly on a mat by ink jet printing.

Moreover, the identification information provided by the thread is less likely to fall off from the mat in contrast to the identification information provided by a pigment affixed to the mat.

By thus providing the identification information with the thread, it may become easier to provide clear identification information firmly on the mat.

When the mat is firmly provided with clear identification information, for example, even unskilled workers tend to more easily discriminate between the front and the back of the holding sealing material.

Further, the thread providing identification information tends not to deteriorate the workability at the time of winding the holding sealing material around the exhaust gas treating body. That is, the holding sealing material of the present embodiment tends to be excellent in a winding property.

(2) In the holding sealing material of the present embodiment, the mat includes a plurality (for example, two sheets) of mats laminated and the plurality (for example, two sheets) of mats are sewn with the thread.

In the holding sealing material of the present embodiment, it may become easier to fix a plurality of mats and provide the identification information with the thread. That is, in accordance with the holding sealing material of the present embodiment, it may become easier to simplify a production process and reduce the number of members for producing the holding sealing material compared with the case where fixing of a plurality of mats and providing of the identification information are carried out by another way.

Further, since the front and the back of the holding sealing material are determined by sewing a plurality of mats with the thread to fix the mats, and since the identification information indicating the front and the back tends to be easily provided concurrently with the fixing of mats, the identification information indicating the front and the back of the holding sealing material is more likely to be prevented from being erroneously provided.

(3) In the holding sealing material of the present embodiment, the thread includes an upper thread exposed at a first face of the holding sealing material, and a bobbin thread exposed at a second face of the holding sealing material, and the color of the upper thread is different from the color of the bobbin thread.

By distinguishing the color of the upper thread exposed at the first face of the holding sealing material from the color of the bobbin thread exposed at the second face of the holding sealing material, a worker tends to simply discriminate between the front and the back of the holding sealing material (the first face of the holding sealing and the second face of the holding sealing material) easily based on the difference in color.

(4) In the holding sealing material of the present embodiment, an organic or inorganic pigment is affixed to a thread. Particularly, the inorganic pigment is preferably affixed to the thread.

Since the pigment is easily affixed to the thread, peeling of the pigment is more likely to be prevented in contrast to the case where the pigment is affixed to the mat.

When the inorganic pigment is used as the pigment, since its heat resistance is high, the identification information tends to remain even after using the holding sealing material at a high-temperature location closed to an engine.

Therefore, even when failures of the holding sealing material occur after using the holding sealing material in a high-temperature environment, it may become easier to identify the identification information such as a manufacturing history of a product and the like.

Hereinafter, examples which specifically disclose the first embodiment of the present invention will be described, but the present invention is not intended to be limited to these Examples.

In the following Examples and Comparative Examples, holding sealing materials having different way to provide identification information, which provides identification information concerning the front and the back of the holding sealing material, were manufactured. Then, the discrimination between the front and the back of the holding sealing material and the durability of the identification information were evaluated.

### Example 1

A base mat having a compounding ratio of Al₂O₃:SiO₂=72:28 was prepared as a base mat made of alumina fibers having an alumina-silica composition. The needled mat having a bulk density of 0.15 g/cm³ and a weight per unit area of 1050 g/m² was manufactured by needling this base mat.

Separately, an acrylic latex emulsion was prepared by sufficiently dispersing an acrylic latex in water, and the emulsion was used as a binder.

Then, the needled mat was cut into a size of 1054 mm in entire length and 295 mm in width in a plan view. The binder was evenly sprayed over the obtained cut needled mat by using a spray so as to give 3.0% by weight of binder with respect to the amount of alumina fibers of the cut needled mat.

Thereafter, by drying the cut needled mat to which the binder adheres at 140° C. for 5 minutes, a shortest mat was manufactured.

A mat located outside the shortest mat was further manufactured by following the same procedure as that described above, except that the entire length was set to 1100 mm. Hereinafter, the further manufactured mat is also referred to as an outermost mat.

Both of the obtained two mats have a weight per unit area of 1050 g/m². Both of the obtained two mats have a thickness of 6.5 mm and are white-colored.

The two mats thus manufactured were laminated so that the positions which equally divide the entire length of each of the mats into two are exactly overlapped with each other, and the shortest mat is laminated on the outermost mat.

Then, a cotton upper thread colored in red by use of an inorganic pigment, and a cotton bobbin thread colored in black by use of an inorganic pigment were loaded on a sewing machine, and machine-sewing was performed to fix the two mats with the thread.

The red upper thread was exposed at a first face (the surface of the shortest mat) of the obtained holding sealing material, and the black bobbin thread was exposed at a second face (the surface of the outermost mat) of the holding sealing material.

A size of a region provided with the identification information with the thread is 1 mm (thread width) and 285 mm (mat width minus 10 mm), and the region provided with the identification information was provided at two locations as shown in FIG. 1.

### Comparative Example 1

Two mats were laminated in the same manner as in Example 1, and then the two mats were fixed by performing machine-sewing by use of cotton threads in which both of the upper thread and the bobbin thread were colored in black to manufacture a holding sealing material.

In order to discriminate between the front and the back of the holding sealing material, characters indicating the front and the back of the holding sealing material were printed on a first face of the holding sealing material by ink jet printing. A size of a character printing region was 10 mm (height) and 105 mm (character width×digit number).

### Comparative Example 2

Two mats were laminated in the same manner as in Example 1, and then the two mats were fixed by performing machine-sewing by use of cotton threads in which both of the upper thread and the bobbin thread were colored in black to manufacture a holding sealing material.

In order to discriminate between the front and the back of the holding sealing material, an adhesive label, on which characters indicating the front and the back were printed, was stuck on a first face of the holding sealing material. A size of a character printing region on the adhesive label was 30 mm (in height) and 80 mm (in length).

### Comparative Example 3

Two mats were laminated in the same manner as in Example 1, and then the two mats were fixed by performing machine-sewing by use of cotton threads in which both of the upper thread and the bobbin thread were colored in black to manufacture a holding sealing material.

In order to discriminate between the front and the back of the holding sealing material, a yellow organic pigment was affixed to an entire first face of the holding sealing material to manufacture a holding sealing material in which the first face was yellow and the second face was white.

### (Evaluation of Discrimination Between Front and Back)

The discrimination between the front and the back of the holding sealing material manufactured in Example and Comparative Examples was visually observed and evaluated.

Specifically, the holding sealing material was place on the 100-cm-high desk, and an observer observed the holding sealing material from a location 50 cm distance from a side, which is closest to the observer, of the holding sealing material and evaluated.

The discrimination between the front and the back of each holding sealing material in Examples and Comparative Examples was evaluated, and the case where the discrimination was easy was denoted by “good”, and the case where the discrimination was not easy was denoted by “bad”. The results are shown in Table 1.

In the holding sealing material manufactured in Example 1, the discrimination between the front and the back was easy since the color of the thread exposed at the first face of the holding sealing material is different from the color of the thread exposed at the second face of the holding sealing material, and clear identification information was provided by the thread.

However, in the holding sealing material manufactured in Comparative Example 1, a print was blurred and the discrimination between the front and the back was not easy.

It is estimated that print by ink jet printing is blurred since the surface of the mat including inorganic fibers is not flat.

In the holding sealing material manufactured in Comparative Examples 2 and 3, the discrimination between the front and the back was easy since clear identification information was provided.

### (Evaluation of Winding Property and Durability of Identification Information)

Each of the holding sealing materials manufactured in Example and Comparative Examples was wound around an exhaust gas treating body having a diameter of 13 inches, and ease of winding in winding the holding sealing material around the exhaust gas treating body, i.e., a winding property was evaluated.

Moreover, the exhaust gas treating body around which the holding sealing material has been wound was placed in the casing to form an exhaust gas purifying apparatus. A vibration test of the exhaust gas purifying apparatus was carried out to verify whether the identification information was retained in an identifiable state (durability of identification information) after the vibration test.

The vibration test was carried out under the conditions of a frequency of 160 Hz, an acceleration of 30 G, an amplitude of 0.58 mm, a retention time of 10 hr, a temperature of room temperature and a vibration direction of z axis (up and down). This vibration test was repeated ten times.

Then, the exhaust gas purifying apparatus was disassembled, and the holding sealing material was taken out, and an appearance of the identification information provided on the surface of the holding sealing material was visually observed to be evaluated.

The winding property in each of holding sealing materials in Example and Comparative Examples was evaluated, and the case where winding was easy was denoted by “good”, and the case where the workability in winding the holding sealing material was poor was denoted by “bad”. The results are shown in Table 1.

Further, the durability of the identification information in each of holding sealing materials in Example and Comparative Examples was visually observed, and the case where the identification information was retained in an identifiable state even after the vibration test was denoted by “good”, and the case where the identification information was not retained in an identifiable state was denoted by “bad”.

In the holding sealing materials manufactured in Example 1, a winding property was excellent and the identification information was retained on the mat in an identifiable state even after the vibration test.

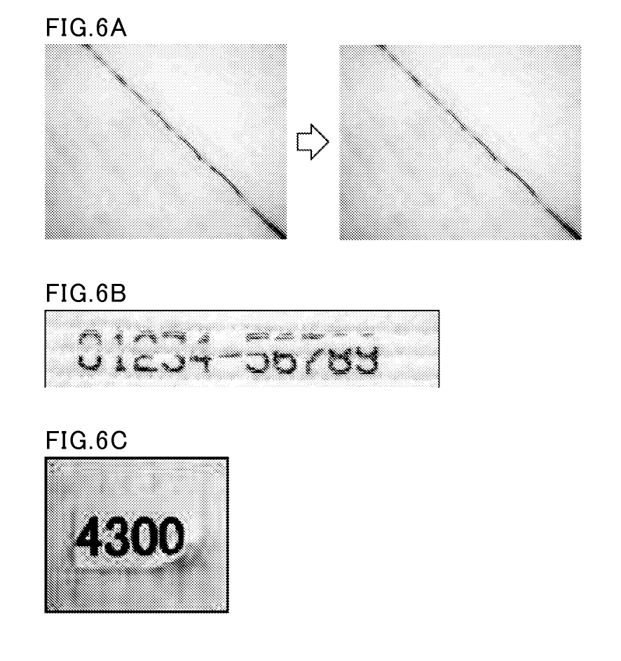

FIG. 6A shows photographs before and after a vibration test of identification information provided by a thread in the holding sealing material manufactured in Example 1.

It is evident from these photographs that there is no change in the state of the thread as the identification information between before the vibration test and after the vibration test.

In the holding sealing material manufactured in Comparative Example 2, a winding property was low since the printed label interferes with a winding operation.

In the holding sealing material manufactured in Comparative Example 1, the print was rubbed to become blurred by vibrations.

FIG. 6B shows photographs before and after a vibration test of identification information provided by ink jet printing in the holding sealing material manufactured in Comparative Example 1.

It is evident from these photographs that the identification information provided by ink jet printing becomes blurred due to rubbing by vibrations.

In the holding sealing material manufactured in Comparative Example 2, by vibrations, the print was rubbed to become blurred and peeling of the adhesive label occurred.

FIG. 6C shows photographs before and after a vibration test of identification information provided by a printed adhesive label in the holding sealing material manufactured in Comparative Example 2.

It is evident from these photographs that the lower right portion of the drawing of the adhesive label with identification information printed is peeled by vibrations.

In the holding sealing material manufactured in Comparative Example 3, by vibrations, the surface of the holding sealing material was shaved and the pigment affixed to the mat was peeled to be thin.

That is, in the holding sealing materials manufactured in Comparative Examples 1 to 3 the identification information was not retained on the mat in an identifiable state after the vibration test.

TABLE 1

| | | Evaluation | | | |
|---|---|---|---|---|---|
| | Way to provide | Discrimination | Durability of | | |
| | identification | between front | identification | Winding | |
| | information | and back | information | property | Note |
| Example 1 | Thread (upper | good | good | good | |
| | thread red, bobbin | | | | |
| | thread black) | | | | |
| Comparative | Print by ink jet | bad | bad | good | Clear print on a mat was |
| Example 1 | printing | | | | difficult |
| Comparative | Printed adhesive | good | bad | bad | When an adhesive label is |
| Example 2 | label | | | | large, discrimination is |
| | | | | | improved but a discharge |
| | | | | | amount of organic |
| | | | | | components increases. |
| Comparative | Coloring of mat by | good | bad | good | A discharge amount of |
| Example 3 | organic pigment | | | | organic components is |
| | | | | | much and retention |
| | | | | | performance is |
| | | | | | deteriorated. |

Thus, in the holding sealing material manufactured in Example 1, the discrimination of the front and the back of the holding sealing material was excellent, and the excellent discrimination could be held in a good condition after the vibration test. Further, the holding sealing material manufactured in Example 1 was also excellent in a winding property.

### Second Embodiment

Next, a second embodiment, which is an embodiment of the holding sealing material according to the present invention, will be described.

In the holding sealing material of the present embodiment, the identification information is information provided in characters, and characters are written by the thread sewn in the mat to provide the information in characters.

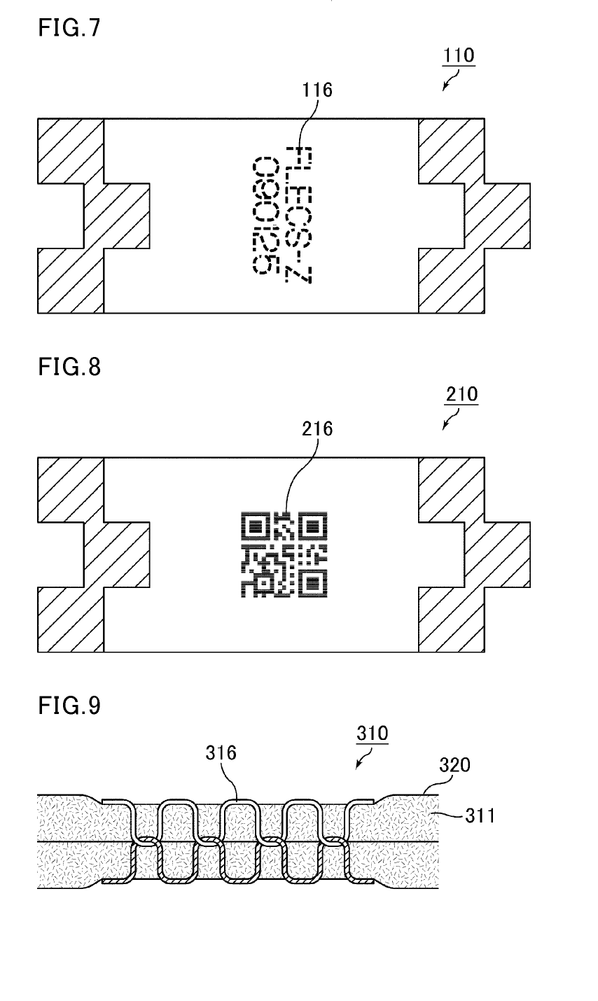

FIG. 7 is a plan view schematically showing an example of a holding sealing material of the second embodiment of the present invention.

In the holding sealing material 110 shown in FIG. 7, the mat is embroidered in the form of characters with a thread 116 and the identification information is provided in characters.

Examples of the information expressed by characters include information concerning a lot number and a product name, and types of the information are not particularly limited.

Further, in the holding sealing material of the second embodiment of the present invention, the identification information may be provided in characters by the thread, and the color of the upper thread and the color of the bobbin thread may be the same or may be different.

When the color of the upper thread is different from the color of the bobbin thread, it may become easier to simply discriminate between the front and the back of the holding sealing material as well as the holding sealing material of the first embodiment of the present invention.

A specific description of other configuration of the holding sealing material of the second embodiment of the present invention will be omitted since other configuration of the holding sealing material is similar to that of the holding sealing material of the first embodiment of the present invention.

Also in the holding sealing material of the second embodiment of the present invention, the following effect can be exerted in addition to the effects (1) to (4), which are the same effects as in the first embodiment of the present invention.

(5) In the holding sealing material of the present embodiment, the identification information is provided in characters by the thread. Since the identification information provided by the thread has high durability, by providing the information expressed in characters such as a lot number by a thread, it becomes easy to identify a manufacturing history of a product even after using the holding sealing material.

### Third Embodiment

Next, a third embodiment, which is an embodiment of the holding sealing material according to the present invention, will be described.

In the holding sealing material of the present embodiment, the identification information is information in two-dimensional codes.

Examples of the Two-Dimensional Code Include QR Code.

FIG. 8 is a plan view schematically showing an example of a holding sealing material of the third embodiment of the present invention.

In the holding sealing material 210 shown in FIG. 8, the mat is embroidered in the form of QR code with a thread 216 and the identification information is provided in two-dimensional codes.

Examples of the information provided in two-dimensional codes include information of a lot number, a product name, a manufacturing history, and a raw material, and types of the information is not particularly limited.

A specific description of other configuration of the holding sealing material of the third embodiment of the present invention will be omitted since other configuration of the holding sealing material is similar to that of the holding sealing material of the first embodiment.

Also in the holding sealing material of the third embodiment of the present invention, the effects (1) to (5), which are the same effects as in the first embodiment and the second embodiment of the present invention, can be exerted.

### Fourth Embodiment

Next, a fourth embodiment, which is an embodiment of the holding sealing material according to the present invention, will be described.

In the holding sealing material of the fourth embodiment of the present invention, in a cross-section formed by cutting the holding sealing material along a thickness direction of the holding sealing material, the surface of the thread sewn in the mat is located below a plane of a part of the mat in which a thread is not sewn.

FIG. 9 is a cross-sectional view schematically showing a part of a cross-section of a holding sealing material of the fourth embodiment of the present invention.

In the holding sealing material 310 shown in FIG. 9, the thread 316 sewn in the mat 311 is receded from and located below a plane 320 including a part of the mat not sewn with thread.

When the thread 316 is located at such a portion, the plane 320 not sewn with a thread of the surfaces of the mat 311 comes into direct contact with the casing or the exhaust gas treating body and the thread 316 hardly comes into direct contact with the casing or the exhaust gas treating body when the holding sealing material is wound around the exhaust gas treating body and placed in the casing.

Therefore, a possibility that the thread comes into contact with the casing or the exhaust gas treating body and is rubbed is low even when vibrations are exerted on the exhaust gas purifying apparatus. Accordingly, the identification information tends to be maintained over a long time period in a clearer state.

Examples of a method for locating the thread sewn in the mat below a plane including the part of the mat not sewn with thread include a method of adjusting tension of the upper thread and/or the bobbin thread. For example, the tension of the thread may be adjusted to the extent so that the holding sealing material does not loosen due to repulsive force of the mat.

Further, when the tension of the upper thread is comparatively decreased and the tension of the bobbin thread is comparatively increased, since a point of intersection of the upper thread and the bobbin thread in a direction of a mat thickness is positioned near the bobbin thread side, it becomes possible to locate the upper thread below a plane including a part of the mat not sewn with thread.

A specific description of other configuration of the holding sealing material of the fourth embodiment of the present invention will be omitted since other configuration of the holding sealing material is similar to that of the holding sealing material of the first embodiment of the present invention.

Also in the holding sealing material of the fourth embodiment of the present invention, the effects (1) to (4), which are the same effects as in the first embodiment of the present invention, can be exerted.

### Fifth Embodiment

Next, a fifth embodiment, which is an embodiment of the holding sealing material according to the present invention, will be described.

In the holding sealing material of the fifth embodiment of the present invention, an initiation point where sewing of the mat with the thread is initiated is about 30 mm or more away from the periphery of the mat.

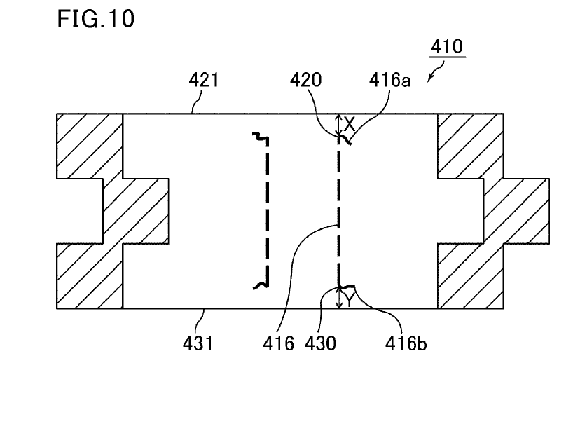

FIG. 10 is a plan view schematically showing an example of the holding sealing material of the fifth embodiment of the present invention.

In the holding sealing material 410 shown in FIG. 10, the mat is sewn with the thread 416 by machine-sewing. A distance (a length indicated by a symbol X in FIG. 10) between the initiation point 420 where sewing of the mat with the thread by machine-sewing is initiated and the periphery 421 of the mat is about 30 mm or more.

When machine-sewing is carried out, a thread 416a of an end portion of the thread 416 becomes a state of free end, which is not sewn, at the point 420.

Further, if the thread which is not sewn in the mat sticks out of the periphery of the holding sealing material in a plan view, since the thread sticking out may interfere with a process of winding the holding sealing material or may hitch on another location. It is not preferable and the workability of a process of winding the holding sealing material may deteriorate.

Generally, a length of the thread which is not sewn in the mat in performing machine-sewing is not about 30 mm or more. Therefore, when the initiation point where sewing of the mat with the thread by machine-sewing is initiated is about 30 mm or more away from the periphery of the mat like the holding sealing material of the present embodiment, the thread which is not sewn in the mat is more likely to be prevented from sticking out of the holding sealing material in a plan view. Therefore, the deterioration of the workability of a process of winding the holding sealing material is more likely to be prevented.

Moreover, it is preferable that a distance (a length indicated by a symbol Y in FIG. 10) between an end point 430 where sewing of the mat with the thread by machine-sewing is ended and the periphery 431 of the mat is about 30 mm or more.

The reason for this is that a thread 416b of an end portion of the thread 416 becomes a state of free end as well as the thread 416a of the end portion also when the thread 416b is not sewn at the end point 430.

A distance between the initiation point where sewing of the mat with the thread is initiated and the periphery of the mat is preferably about 50% or less of a mat width (a distance indicated by an arrow W in FIG. 1). When the distance is about 50% or less of the mat width, the mat tends not to turn upward from a side parallel to a longitudinal direction of the mat.

It is more preferable that a total of the distance (a length indicated by a symbol X in FIG. 10) between the initiation point where sewing of the mat by the thread is initiated and the periphery of the mat, and the distance (a length indicated by a symbol Y in FIG. 10) between an end point where sewing of the mat with the thread by machine-sewing is ended and the periphery of the mat is about 50% or less of the mat width.

A specific description of other configuration of the holding sealing material of the fifth embodiment of the present invention will be omitted since other configuration of the holding sealing material is similar to that of the holding sealing material of the first embodiment of the present invention.

Also in the holding sealing material of the fifth embodiment of the present invention, the effects (1) to (4), which are the same effects as those in the first embodiment of the present invention, can be exerted.

### Other Embodiments

The holding sealing material according to the embodiment of the present invention is not limited to the aspect of a plurality of mats laminated, and the holding sealing material according to the embodiment of the present invention may have only one mat.

Firm and clear identification information tends to also be provided for the holding sealing material having only a mat by the thread sewn in the mat.

Although the number of mats is one, it is necessary to discriminate between the front and the back of the mat and it is effective to provide identification information written in characters.

The aspect of lamination in the case where mats are laminated is not limited to an aspect as shown in FIG. 1 in which the shortest mat is laminated on another mat at a position which does not stick out of either one of the ends of another mat in a plan view.

For example, the shortest mat may be laminated on a mat having the longer entire length (hereinafter, also referred to as a long mat) than that of the shortest mat so as to be mutually displaced in the longitudinal direction. Specifically, the aspect, in which in a plan view, the left edge of the shortest mat sticks out of the left edge of the long mat and the right edge of the long mat significantly sticks out of the right edge of the shortest mat, may be employed.

Further, the aspect, in which the left edge of the shortest mat is aligned with the left edge of the long mat and the right edge of the long mat sticks out of that of the shortest mat, may be employed.

The holding sealing material according to the embodiment of the present invention may be provided with identification information by sewing cloths with the thread. In this case, identification information may be provided on the cloths by printing or the like. The identification information, provided by sewing the mat with the thread, is less likely to be peeled off and tends to be excellent in durability against vibrations compared with the identification information, provided by sticking an adhesive label.

Examples of the material of the thread in the holding sealing material according to the embodiment of the present invention include cellulosic fibers such as rayon, cuprammonium rayon, and acetate, synthetic fibers such as nylon, tetron, acryl, vinylon, operon, polyethylene, Teflon®, vinyl chloride, and vinylidene chloride, natural fibers such as cotton and silk, and the like.

In the holding sealing material according to the embodiment of the present invention, a stitching method for performing machine-sewing is not limited to the above-mentioned lock stitching, and for example, basting or the like may be employed.

Among these methods, lock stitching is more preferable. The reason for this is that it may become easier to fix the mats one another more firmly.

Upon performing machine-sewing in the holding sealing material according to the embodiment of the present invention, a method for twisting a thread is not particularly limited, and a first twist may be performed in the first yarn stage, or a second twist may be performed after yarn doubling. Also, a Z twist (left-handed twist) or an S twist (right-handed twist) may be used, and in order to prevent a twist back due to rotation of a shuttle of the sewing machine, it is desirable to use the Z twist as the second twist.

The shapes of a recessed portion and a projected portion which are formed on a shorter side of the holding sealing material according to the embodiment of the present invention are not particularly limited as long as the shapes enable the recessed portion to be easily fitted to the projected portion. In the case where one set of a recessed portion and a projected portion is formed, desirably, the projected portion which projects over a size from about 10 mm in width and about 10 mm in length to about 300 mm in width and about 100 mm in length is formed on a part of one shorter side, and the recessed portion which is fitted to the projected portion is formed on a part of the other shorter side. In the case where an exhaust gas purifying apparatus is manufactured using the holding sealing material having such shapes of the recessed portion and the projected portion, an exhaust gas treating body tends to be surely held by the holding sealing material, better leading to excellent handleability.

In addition, a plurality of the recessed portions and projected portions which are fitted to each other may be formed in the shorter side of the holding sealing material, or recessed portions and projected portions may not be formed therein.

The inorganic fibers which form the mats are not particularly limited, and may be alumina-silica fibers, or may be alumina fibers, silica fibers, or the like. The inorganic fibers may be glass fibers. It is only necessary to change the species of the inorganic fibers based on the characteristics, such as heat resistance, resistance to wind erosion and the like, required of the holding sealing material. In the case of using alumina-silica fibers as inorganic fibers, for example, the fibers can be used in which the composition ratio of alumina to silica is about 60:about 40 to about 80:about 20.

The average fiber length of inorganic fibers forming the mat is desirably from about 30 μm to about 120 mm, and more desirably from about 50 μm to about 100 mm. In addition, the average fiber diameter of inorganic fibers is desirably from about 2 μm to about 12 μm, and more desirably from about 3 μm to about 10 μm.

The organic binder used for manufacturing the holding sealing material is not limited to the acrylic-based resin, and examples thereof include rubbers such as acrylic rubber, water-soluble organic polymers such as carboxymethyl cellulose or polyvinyl alcohol; thermoplastic resins such as styrene resin, thermosetting resins such as epoxy resin, and the like. Among these, acrylic rubber, acrylonitrile-butadiene rubber, and styrene-butadiene rubber are particularly desirable.

The material for the casing composing the exhaust gas purifying apparatus is not particularly limited as long as it is a heat-resistant metal, and specific examples of the material include metals such as stainless steel, aluminum and iron.

The exhaust gas treating body composing the exhaust gas purifying apparatus may be prepared as an integral exhaust gas treating body configured by one sintered body as a whole, as shown in FIG. 4A, or may be prepared as an aggregated exhaust gas treating body obtained by using adhesive layers and binding a plurality of honeycomb fired bodies, each having a structure in which a large number of cells are longitudinally disposed in parallel with one another, with a cell wall being interposed therebetween.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A holding sealing material comprising:
at least one mat comprising inorganic fibers; and
at least one thread sewn in said at least one mat to provide identification information on said at least one mat.

2. The holding sealing material according to claim 1,
wherein said at least one mat comprises a plurality of mats that are laminated, and
wherein said plurality of mats are sewn with said at least one thread.

3. The holding sealing material according to claim 1,
wherein said at least one thread comprises
an upper thread exposed at a first face of the holding sealing material, and
a bobbin thread exposed at a second face of the holding sealing material, a color of said upper thread being different from a color of said bobbin thread.

4. The holding sealing material according to claim 1,
wherein an organic pigment or an inorganic pigment is affixed to said at least one thread.

5. The holding sealing material according to claim 4,
wherein an inorganic pigment is affixed to said at least one thread.

6. The holding sealing material according to claim 1,
wherein, in a cross-section formed by cutting the holding sealing material along a thickness direction of the holding sealing material, a surface of the at least one thread sewn in said at least one mat is located below a plane of a part of said at least one mat where a thread is not sewn.

7. The holding sealing material according to claim 1,
wherein an initiation point where sewing of said at least one mat with said at least one thread is initiated is about 30 mm or more away from a periphery of said at least one mat.

8. The holding sealing material according to claim 2,
wherein the plurality of mats are fixed to each other by two portions sewn with the at least one thread.

9. The holding sealing material according to claim 1,
wherein a maximum length of a region provided with the identification information by the at least one thread is about 50 mm or more.

10. The holding sealing material according to claim 1,
wherein a maximum length of a region provided with the identification information by the at least one thread is substantially equal to a mat width of said at least one mat.

11. The holding sealing material according to claim 1,
wherein the identification information comprises information expressed by characters, and
wherein the characters are embroidered with the at least one thread sewn on the at least one mat.

12. The holding sealing material according to claim 1,
wherein the identification information is provided in two-dimensional codes.

13. The holding sealing material according to claim 1,
wherein an end point where sewing of the at least one mat with the at least one thread is ended is about 30 mm or more away from a periphery of the at least one mat.

14. The holding sealing material according to claim 1,
wherein a distance between a periphery of the at least one mat and an initiation point where sewing of the at least one mat with the at least one thread is initiated is about 50% or less of a mat width of said at least one mat.

15. The holding sealing material according to claim 1,
wherein a distance between a periphery of the at least one mat and an end point where sewing of the at least one mat with the at least one thread is ended is about 50% or less of a mat width of said at least one mat.

16. The holding sealing material according to claim 1,
wherein a number of the at least one mat is one.
